(19) United States
(12) Patent Application Publication
(10) Pub. No.: US 2010/0032413 A1
(43) Pub. Date: Feb. 11, 2010

(54) Method and device for the crack-free welding, repair welding, or surface welding of materials prone to forming hot cracks

(76) Inventors: Berndt Brenner, Dresden (DE); Gunther Goebel, Radeberg (DE)

Correspondence Address: JACOBSON HOLMAN PLLC, 400 SEVENTH STREET N.W., SUITE 600, WASHINGTON, DC, 20004, US

(21) Appl. No.: 12/311,775

(22) PCT Filed: Oct. 10, 2007
(86) PCT No.: PCT/EP2007/008786

§ 371 Date: Apr. 13, 2009

(30) Foreign Application Priority Data
Oct. 13, 2006 (DE) 102006048580.7-45

(51) Int. Cl. B23K 9/04; B23K 15/00; B23K 9/10; B23K 9/16

(52) U.S. Cl. 219/75; 219/121.14; 219/130.1; 219/76.1

(57) ABSTRACT

The invention relates to a method and a device for crack-free welding, repair welding, or buildup welding of metallic materials which are susceptible to hot cracking. Objects in which its application is expedient and advantageous are all components which comprise multiphase solidification alloys having a broad solidification interval or are constructed from alloys which contain alloy elements or contamination elements which form a low-melting-point eutectic material with one or more main alloy elements and which are to be joined using fusion welding methods of high power density.

In the method according to the invention, the traveling local temperature application is performed by two electromagnetic temperature fields, which run parallel or nearly parallel to the welding direction on both sides, and extend longitudinally to the welding direction, are generated by a volume energy source in the interior of the components, both temperature fields beginning in front of the welding zone viewed in the welding direction and their temperature maxima being located outside the thermal influence zone and behind the solidification zone in the welding direction, the depth of the temperature fields at least reaching the weld seam depths at the location of the temperature maximum.

In the device according to the invention, the auxiliary energy source is a volume energy source and is connected to the welding head and follows the movement of the welding head.

The invention relates to the welding of metallic components made of materials susceptible to hot cracking. Objects in which its application is expedient and advantageous are all components which comprise multiphase solidification alloys having a broad solidification interval or are constructed from alloys which contain alloy elements or contamination elements which form a low-melting-point eutectic material with one or more main alloy elements and which are to be joined using fusion welding methods of high power density. Such materials, which have only been able to be welded crack-free inadequately up to this point, are, for example, ferritic, ferritic-perlitic, or austenitic machining steels, hardenable aluminum alloys, austenitic steels endangered by hot cracking, nickel alloys, etc. The invention is especially advantageously usable for all welding tasks in which, for reasons of method technology, properties, or cost-effectiveness, no welding additive material may be applied to ensure the ability to weld without hot cracking or the use of welding additive materials is inadequate to reliably avoid hot cracking in processing.

Further potential fields of use are the avoidance of so-called middle rib defects in laser beam welding of figure plates made of construction steels, of middle rib cracks in the welding zone of thin plates made of austenitic stainless steels, and of very rigid or very hard clamped components.

In addition, the method may also be used to avoid hot cracks in the welded material during repair or buildup welding.

### STATE OF THE ART

Hot cracks are a severe welding problem, which prevents the use of economically important alloys, which are advantageous in use, in an array of welding structures. They predominantly occur in multiphase solidification alloys, in alloys having secondary alloy or contaminant elements, which form a low-melting-point eutectic material with one or more alloy elements, and in cases of very rapid solidification running in the direction of the plate plane or in very rigid weld seam surroundings.

Correspondingly, extensive and manifold efforts and attempted solutions known up to this point have been made to solve the problem of hot cracking.

Thus, for example, the attempt has been made to remove the metallurgical causes of the hot crack formation—the formation of low-melting-point phases or of grain boundary films—by the use of suitable welding additive materials. However, in spite of its broad technical application, this method is not suitable in every case. Thus, for example, suitably adapted welding additive materials do not exist for every alloy susceptible to hot cracking. In addition, the welding process typically becomes more expensive. Furthermore, it may be disadvantageous that in ultra-high-strength materials, the mechanical carrying capacity of the weld seam may decrease due to the use of welding additive materials, which shift the composition of the welded material in the direction of eutectic solidification. Furthermore, it is generally disadvantageous that the primary cause of the hot crack formation—exceeding critical tensile elongations and/or critical elongation rates during the solidification in the two-phase region—is not thus combated.

Various methods have become known for avoiding critical elongation and/or elongation rates during the solidification in the two-phase region. Thus, for example, a method is described in WO 03/031108 (W. Kurz, J.-D. Wagniere, M. Rappaz, F. de Lima: “Process for Avoiding Cracking in Welding”), with the aid of which the hot cracking occurring during the laser beam welding of aluminum alloys is combated, in that a second heat source—preferably a laser—follows a first heat source—preferably also a laser—at a constant distance, the second heat source is oriented directly on the solidification zone, and the power of the second heat source is set so that the local cooling rate of surface-proximal areas of the solidification zone is reduced or these are even briefly heated locally once again. The additional trailing heat source may comprise an electron beam, laser beam, electric arc, or plasma source or also a combination of two sources and operates using a lower power density than the first heat source.

Using a 1.7 kW CO₂ laser as the welding laser and a 1.2 kW pulsed Nd:YAG laser as the second heat source, 1.0 mm thick plates made of the aluminum alloy 6016 may be welded in an I-butt without hot cracking. The best results were achieved when, at a feed rate of vₛ=3.6 m/minutes, the Nd:YAG laser beam, which was focused on a focus diameter of d_{f}=0.6 mm, was situated at a distance of 3 mm behind the center point of the CO₂ laser beam. Due to the local second energy introduction using a pulse energy of 8 J, a pulse intensity of 30 W/cm², and a frequency of 150 Hz, an enlarged melt bath and a reduction of the local quenching rate from 2600 K/s to 1500 K/s were achieved. It proved to be decisive for the action mechanism that the second laser beam acts directly on the solidification zone. The following effects, which counteract the hot crack formation, are thus achieved according to the findings of the inventor:
reducing the temperature gradients and the cooling speed at the surface of the solidification zone,
increasing the period of time in which the melt may be fed further into the solidification zone,
occurrence of a coaxial microstructure in the central plane of the welding zone.

The disadvantage of this solution in application technology is that only thin plates may be welded therewith out hot cracking. The reason for this is that the laser energy of the second laser is only absorbed on the surface and the thermal penetration depth during the very brief interaction time of the laser beam with the surface of the solidification zone, of at most Δt=(d_{f}/vₛ)=(0.6 mm/3600 mm)min=0.01 seconds, is only very small. Therefore, the depth of the zone having reduced cooling speed is very small. Similar behavior occurs upon the application of the other claimed energy sources for the second heat source. The depth of the zone having reduced cooling speed becomes even less if steels, having their much lower thermal conductivity, are to be welded according to this method.

Similarly to this above-mentioned solution of the prior art, for the welding of thin aluminum plates without hot cracking (see, for example: V. Ploshikin, A. Prikhodovsky, M. Makhutin, A. Ilin, H.-W. Zoch “Integrated Mechanical-Metallurgical Approach to Modeling of Solidification Cracking in Welds” in: Th. Böllinghaus, H. Herold (editors): Hot Cracking Phenomenon in Welds, Springer Verlag 2005, ISBN 3-540-2232-0, pages 223-244), situating a second defocused laser beam adjacent to the strongly focused laser beam for welding and moving the second laser beam parallel to the first laser beam and at the same speed, has also become known. A 2.0 mm thick aluminum plate of the alloy AA6056, which was solidly clamped on one side, was welded using a laser power of 1.8 kW and a feed rate of 2.8 m/minute. At a distance of the weld seam of approximately 25 mm from the lateral sample edge, a complete sample separation occurred due to longitudinally running hot cracks after the welding. If the plate was continuously heated locally at a laser power of 750 W using the second laser, which was located at a distance of approximately 20 mm adjacent to the weld seam on the free, unclamped plate side, hot cracks were able to be avoided.

It is also disadvantageous in this solution that the method is only suitable for thin plates. The cause of this shortcoming is, as in the above-mentioned first example, the laser also only acts as a surface energy source in this method. In addition, this solution is also too costly for crack avoidance for many practical applications. The reason is that an expensive laser must also be used for the second heat source.

Preventing cracks in the thermal influence zone in that the welding and heating of the weld seam surroundings are caused quasi-simultaneously by the same electron beam, in that, in very rapid succession, the focused electron beam welds in pulses using a high power density and is then defocused and deflected for the heat treatment, has become known from the field of the electron beam welding (see GB 2,283,448 A, Th. K. Johnson, Al. L. Pratt: “Improvements in or relating to electron beam welding”). The surface temperatures may thus be set in a targeted way in front of, adjacent to, and behind the welding zone.

It is also disadvantageous here that the energy source for generating the secondary temperature fields represents a surface energy source, whose effectiveness does not extend far enough into the material to also be sufficiently effective for the case of avoidance of hot cracks in the welding zone with deeper weld seams and materials of worse thermal conductivity. The cause of this is again that the energy of the electron beam is completely absorbed in the uppermost boundary layers and propagates too slowly into the depths in relation to the high welding speed of the beam welding method. In contrast, if the positions of the regions to which the electron beam is applied for the heat treatment are placed so far in front of the welding position that the additional temperature field also reaches the weld base in the position of the welding zone, the temperature field no longer acts locally, but rather more like a general homogeneous preheating. From our own experiments it is known, however, that a homogeneous preheating is not sufficiently effective for hot crack avoidance. In addition, it is disadvantageous that these methods may only be used for electron beam welding under vacuum.

The object of the invention is therefore to specify a novel and effective method and a novel device for crack-free welding, repair welding, or buildup welding of materials susceptible to hot cracking, which is also suitable for greater weld seam depths and greater plate thicknesses, for multiple welding methods—also particularly usable in atmosphere, for a broader palette of metallic materials, and particularly also those materials having worse thermal conductivity, and which may additionally be implemented significantly more cost-effectively than the known prior art.

### STATEMENT OF THE OBJECT

The invention is based on the object of specifying a welding method and a device usable therefor, which allows the tensile elongations, which occur during the cooling in the temperature interval of brittleness, to be avoided or at least suppressed to a harmless level in the solidification zone.

The object is achieved according to the invention by a novel method for crack-free welding, repair welding, or buildup welding of materials susceptible to hot cracking, as described in Claim 1, and a corresponding device, as specified in Claim 10.

According to Claim 1, the solution according to the invention for welding methods using high power density is that instead of the surface energy sources used according to the prior art, electromagnetic volume sources are used as the auxiliary energy source in such a way that, in the interior of the component, they generate two specially implemented inhomogeneous temperature fields, which travel with the welding zone, run parallel or nearly parallel to the welding direction on both sides, and extend longitudinally to the welding direction. The two temperature fields begin in front of the welding zone viewed in the welding direction. Their temperature maxima are located outside the thermal influence zone and behind the solidification zone of the weld seam in the welding direction, their depths at least reaching the weld seam depths at the location of the temperature maxima.

Welding methods for which the method according to the invention may be employed are specified in Claims 2 through 4.

The idea that the invention is not restricted, as stated in Claim 2, solely to the welding method of high power density being a laser beam welding method. As specified in Claims 3 and 4, plasma, TIG, WIG, or non-vacuum electron beam welding facilities may just as well be used.

Claim 5 contains an especially advantageous variant for generating the additional temperature fields using inductive heating. As stated in Claim 6, the temperature field according to the invention may also be generated using conductive heating.

Method-influencing variables for setting the depth and extension of the additional temperature fields by selecting the induction frequency, the length, shape, and extension of the two inductor branches, the attachment of field amplification elements, and the induction frequency are specified in Claim 7.

Claims 8 and 9 give ideas for the design of the temperature fields as a function of the component geometry and if different materials are to be welded with one another.

Device Claim 10 states that the auxiliary energy source is a volume source which is connected to the welding head in such a way that it follows the movement of the welding head at the same speed. It is stated in Claim 16 that the device may advantageously be used to perform the method according to at least one of Claims 1 through 9.

Claims 11 through 13 refine the idea of the invention for the case that the auxiliary energy source is an inductor. A solution alternative thereto by the use of conductive heating is stated in greater detail in Claims 14 and 15.

The advantages of the solution according to the invention in relation to the prior art are that it
is capable of welding very critical materials, which are very strongly sensitive to hot cracking, without hot cracking,
has a greater flexibility in the design of the additional targeted influencing of the elongation state in the solidification zone in the temperature range of hot cracking,
is suitable for greater weld seam depths, plate thicknesses, and also for very high welding speeds,
allows a broader palette of materials susceptible to hot cracking to be welded without hot cracking without the use of welding additive materials,
is also usable for metallic materials having very poor thermal conductivity,
is significantly more cost-effective than the solutions suggested according to the prior art for avoiding hot cracks by auxiliary energy sources such as lasers or electron beams.

### LIST OF REFERENCE NUMERALS

1 component 1 to be welded
2 component 2 to be welded
3 energy beam of the welding method
4 welding zone
5 keyhole
6 solidification zone
7 solidified weld bead, weld seam
8 welding direction SR
9 temperature field 1
10 temperature field 2
11 isothermal of the temperature fields
12 weld seam depth tₛ
13 temperature maximum of the electromagnetically generated temperature field
13′ temperature maximum Tₘₐₓ₁ of the temperature field 1(9)
13″ temperature maximum Tₘₐₓ₂ of the temperature field 2 (10)
14 thermal influence zone WEZ
15 inductor
16 power supply
17 power removal
18 inductor branch 1
19 inductor branch 2
20 inductor connection part
21 magnetic field amplification elements
22 volume energy source, auxiliary energy source
23 welding head
24 power collector on top of component 1
25 power collector on bottom of component 1
26 power collector on top of component 2
27 power collector on bottom of component 2
28 top of component 1
29 bottom of component 1
30 top of component 2
31 bottom of component 2
32 welding energy source
33 join plane
34 current path
aₓ distance between the beginning of the temperature fields 1 and 2 and the center point of the welding zone (4); aₓ is a positive number if the welding zone leads
bᵢ smallest distance between inductor branch 1 (18) and inductor branch 2 (19)
b_{SZ} width of the welding zone (4) on the top of the components 1 and 2 (1, 2)
bₓ distance between center point of the welding zone (4) and the end of the solidification zone (6)
cₓ distance between end of the solidification zone (6) and the temperature maximum (13) of the temperature fields 1 or 2 (9, 10)
d plate thickness
d_{f} focus diameter of the laser beam
lᵢ length of the inductor branches
l_{i1;2} length of the inductor branch 1 (18) or 2 (19)
l_{SEZ} length of welding zone (4) and solidification zone (6) in welding direction SR
t_{S} weld seam depth (12)
v_{S} feed rate, welding speed
x coordinate longitudinal to the welding direction (8)
y coordinate transverse to the welding direction (8)
z_{i1;2;3} coupling distance, i.e., distance of the two inductor branches 1 (18) or 2 (19) or the inductor connection part (20) to the component 1(1) or 2(2)
RT room temperature
SR welding direction
T^{Ez}ₘₐₓ temperature maximum in the solidification zone (6)
T_{max1;2} temperature maximum of the temperature fields 1 and 2 (9, 10)
Tₚᵣₑ temperature in the join line directly before the welding zone (4)
Tₚₒₛₜ maximum temperature in the weld seam (7) after the welding zone (4) below an inductor situated symmetrically above the weld seam
WEZ thermal influence zone
ΔT_{IS} temperature interval of brittleness

### EXEMPLARY EMBODIMENTS

The invention is explained in greater detail on the basis of the following exemplary embodiments. Identical features are provided with identical reference numerals in the figures.

In the figures:

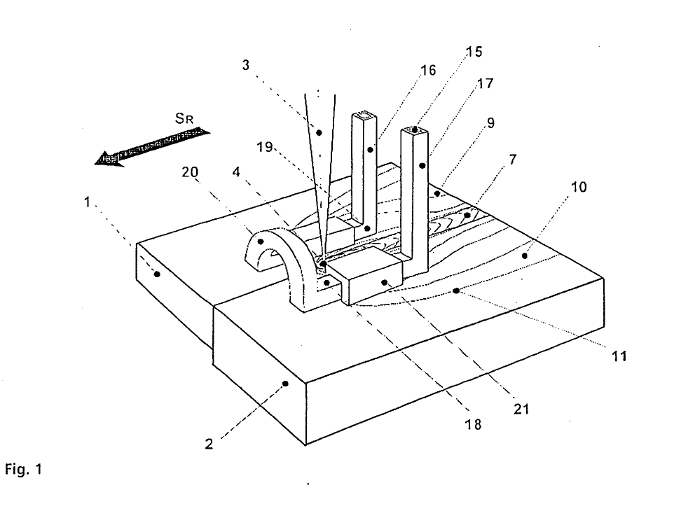

FIG. 1: shows a configuration according to the invention of welding energy source and auxiliary energy source

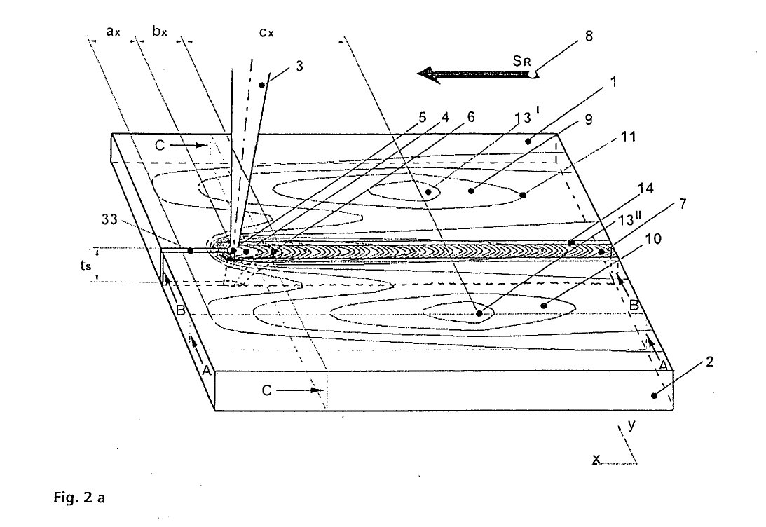

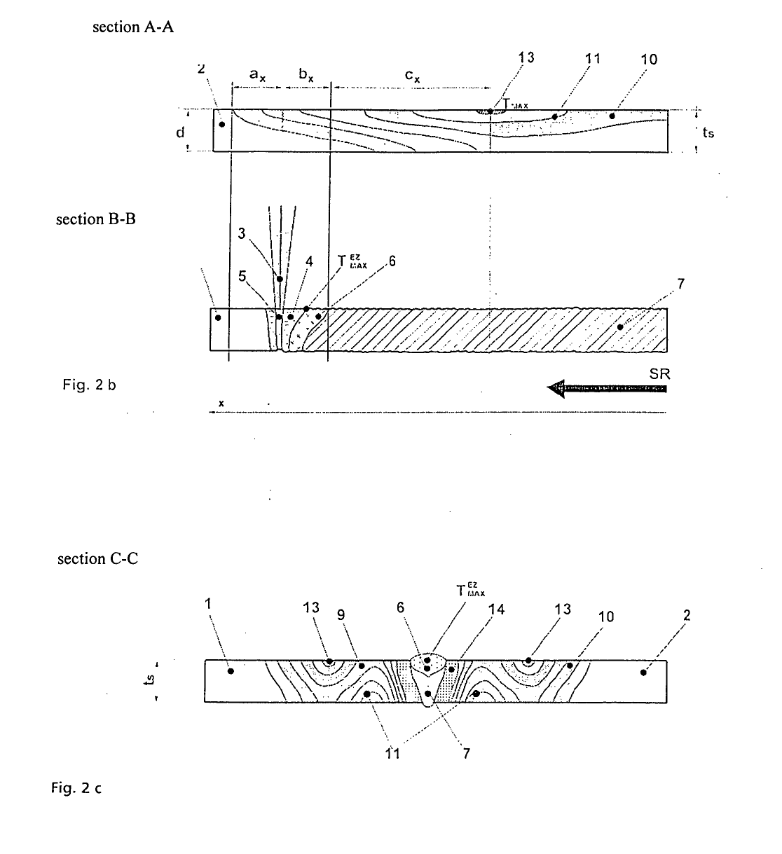

FIG. 2a: shows a temperature field implementation according to the invention to avoid hot crack formation

FIG. 2b: shows a longitudinal section AA through one of the two temperature fields generated by the auxiliary energy source, and an associated longitudinal section BB along the line of symmetry of the weld seam

FIG. 2c: shows a cross-section CC through the weld seam and the superimposed temperature fields of welding energy source and auxiliary energy source in a plane through the solidification zone

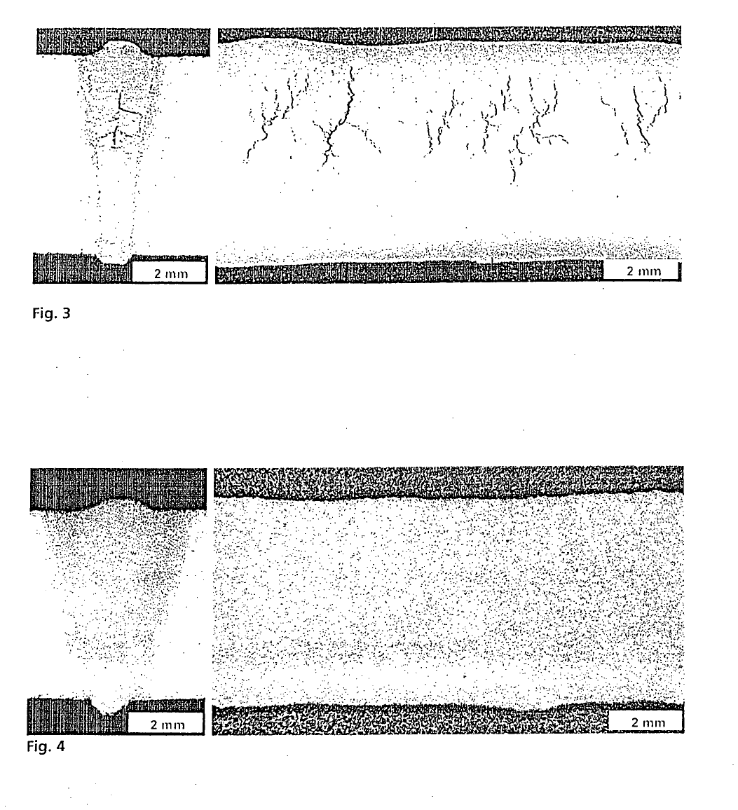

FIG. 3: shows hot cracks in the transverse and longitudinal grinds of a laser-welded seam

FIG. 4: shows a weld seam generated without hot cracking according to the invention

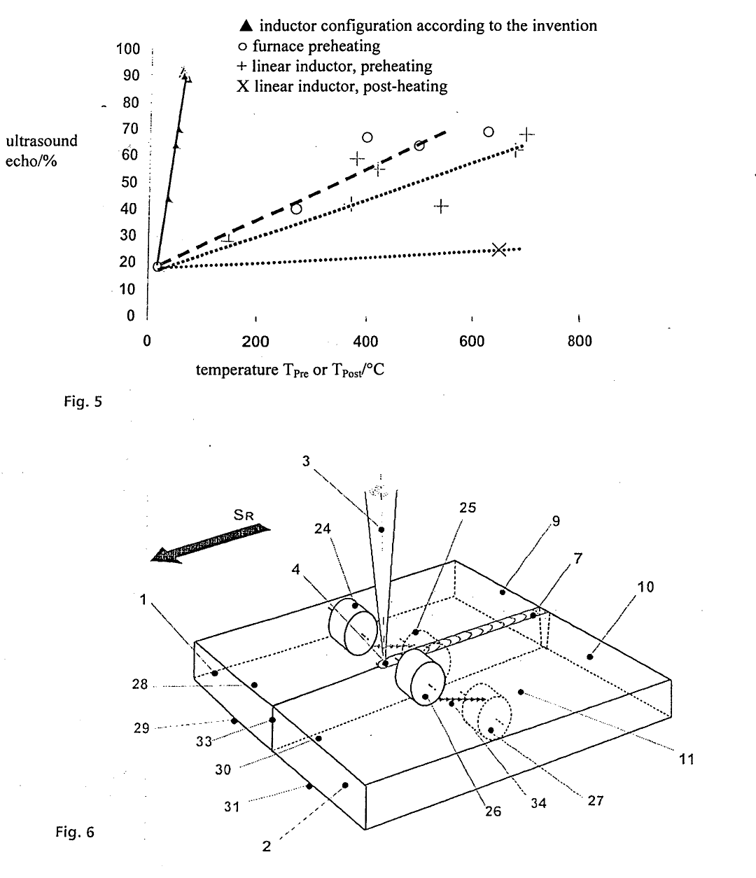

FIG. 5: shows the reduction of the tendency toward hot cracking as a function of the temperature in proximity to the welding zone (Tₚᵣₑ—temperature in the join line directly before the welding zone (4), Tₚₒₛₜ—maximum temperature in the weld seam (7) after the welding zone (4)) for various auxiliary energy sources: homogeneous preheating of the entire sample in the furnace; linear inductor symmetrically above the join line directly in front of the welding zone (4), linear inductor above the weld seam (7) directly after the solidification zone (6); inductor configuration according to the invention

FIG. 6: shows a configuration according to the invention of welding energy source and volume energy source in the form of a conductively acting auxiliary energy source

### EXAMPLE 1

The solution according to the invention will be explained on the basis of the fundamental construction of the device and the general method steps.

Two plates (1, 2) made of a material sensitive to hot cracking are to be bonded to one another by welding through an I-butt (see FIG. 1). A CO₂ laser, a Nd:YAG laser, a fiber laser, a high-power diode laser, a non-vacuum electron beam cannon, or a plasma welding burner may be used as the welding energy source (32). A volume energy source (22) is connected fixed to the welding head (23) as an auxiliary energy source. For this purpose, an inductive or conductive energy coupling may be used. In the exemplary embodiment, an inductive energy coupling using a moderate frequency generator is selected. In this case, the auxiliary energy source comprises an inductor (15), which is constructed from two inductor branches 1 and 2 (18, 19), situated parallel to the weld seam (7), an inductor connection part (20), and the power supply (16) and the power removal (17). To increase the energy transmission efficiency and the variation of the position, height, and extension of the temperature field maxima Tₘₐₓ₁ (13′) and Tₘₐₓ₂ (13″), magnetic field amplification elements (21) may be located on one or both inductor branches 1 and/or 2 (18 and/or 19).

After the auxiliary energy source (22) and the welding energy source (32) are turned on, the welding process is started. In general, the auxiliary energy source (22) moves at the same feed rate v_{S} as the welding energy source (32). During the movement, the auxiliary energy source (22) generates two additional temperature fields 1 and 2 (9, 10), see FIG. 2a. They are located on both sides of the weld seam (7) and extend from a position in front of the weld zone (4) up to at least behind the solidification zone (6). The temperature field maxima Tₘₐₓ₁ and Tₘₐₓ₂ (13′, 13″) of the two temperature fields (9, 10) are located behind the solidification zone (6) in the welding direction SR (8) and outside the thermal influence zone (see FIG. 2b and FIG. 2c). The location of the temperature field maxima Tₘₐₓ₁ and Tₘₐₓ₂ (13′, 13″) is set transversely to the welding direction SR (8) by the distance of the two inductor branches (18, 19), and longitudinally to the welding direction SR (8) by the positioning of the inductor (15) in relation to the energy beam of the welding method (3), the length and shape of the inductor branches (18, 19), the attachment, implementation, and positioning of magnetic field application elements (21), and the coupling distance between component (1, 2) and the inductor branches (18, 19). The level of the temperature maxima Tₘₐₓ₁ and Tₘₐₓ₂ (13′, 13″) is predetermined by the selection of the inductor current.

In the general case of curved weld seams (7), different plate thicknesses, or different materials of the two components 1 and 2 (1, 2) to be welded, the temperature fields (9 and 10) and the levels of the temperature field maxima Tₘₐₓ₁ and Tₘₐₓ₂ (13′, 13″) do not necessarily have to be equal and lie completely symmetrical to the weld seam (7). The induction frequency is selected as a function of the plate thickness and the electromagnetic properties of materials so that the depth of the temperature fields (9, 10) at least reaches the weld seam depth t_{S} (12) at the location of the temperature field maxima Tₘₐₓ₁ and Tₘₐₓ₂ (13′, 13″) (see also FIG. 2b and FIG. 2c).

### EXAMPLE 2

Machining steels have an increased sulfur content to improve the cutting ability and the formation of short breaking chips. This sulfur forms low-melting-point eutectic materials with the iron upon fusion, which result in hot cracking upon welding. Machining steels are therefore considered non-weldable. This increasingly applies to the heat-treating steels, which additionally have a carbon content greater than approximately 0.3% to ensure their temperability. Although the procedure according to the invention may also be applied advantageously to other materials endangered by hot cracking, such as austenitic steels, aluminum alloys, and nickel alloys, the suitability of the method is to be shown on the basis of the example of heat-treating machining steels because of the special difficulty and the lack of suitable alternative solutions, such as welding additive materials which avoid hot cracking.

Two plates, which are 250 mm long, 100 mm wide, and 6 mm thick, and are made of heat-treating machining steel 45S20 (chemical composition: approximately 98% iron; 0.43% carbon, 0.201% sulfur; 0.25% silicon; 0.94% manganese; 0.018% phosphorus) are to be joined on their longitudinal side using laser beam welding. A cross-flow 6 kW CO₂ laser is to be used as the welding energy source (32) for the laser beam welding. The laser beam power is set to 5.5 kW. The welding speed v_{S} is v_{S}=1.5 m/minute. Helium is supplied in a quantity of 15 l/minute using a trailing nozzle configuration as a protective gas.

Although the weld seam is well implemented, it has a plurality of transverse and longitudinal hot cracks, as transverse and longitudinal grinds show (see FIG. 3), which make the use of plates produced in this way impossible.

To avoid hot cracking, an inductive energy source is used as the auxiliary energy source (22). The induction generator has a frequency of 9 kHz. The double-armed inductor (schematic illustration in FIG. 1) comprises two linear inductor branches 1 and 2 (18, 19) having a cross-section of 8×8 mm². Both inductor branches (18, 19) are lᵢ=lᵢ₁=lᵢ₂=60 mm long, have a distance of bᵢ=20 mm, and have current flowing through them antiparallel. The coupling distance is 2.0 mm and is constant over the entire inductor length. The magnetic field amplification elements (21) for both inductor branches (18, 19) comprise 44 mm long Fluxtrol® pieces, worked out in a U-shape.

The inductor is positioned centrally to the weld seam (7). A value aₓ≈20 mm is selected as the distance aₓ between the beginning of the temperature fields 1 and 2 (18, 19) and the center point of the welding zone (4), approximately measured as the smallest distance between the center line of the energy beam of the welding method (3) and the connection line between the two front edges of the inductor branches 1 and 2 (18, 19). The inductive power is set to an effective power display on the induction generator of 20 kW.

The length l_{SEZ} of the welding zone (4) and the solidification zone (6) totals l_{SEZ}≈22 mm. To perform the welds, the same welding parameters are set as for the welds without auxiliary energy source. The inductor (15) is moved simultaneously with the welding head (23). Upon reaching the starting position, the inductor (15) and the laser beam are turned on, the laser beam with a time delay.

Using the setting parameters, a temperature maximum Tₘₐₓ=Tₘₐₓ₁=Tₘₐₓ₂=850° C. is reached. The temperature maxima Tₘₐₓ₁ and Tₘₐₓ₂ are approximately bₓ+cₓ≈32 mm behind the position of the center point of the energy beam of the welding method (3). The distance bₓ between the center point of the welding zone (4) and the end of the solidification zone (6) is approximately bₓ≈20 mm. Therefore, for the selected length of the inductor branches, lᵢ₁=lᵢ₂≈3*l_{SEZ}, and for the distance bᵢ between the inductor branches, bᵢ≈5*b_{SZ}.

FIG. 4 shows a transverse grind and a longitudinal grind of the weld seam produced according to the method according to the invention. The seam is completely free of cracks. The freedom from cracks is accompanied by a drastic improvement of the mechanical properties of the welded plates. The tensile strength of the weld seam in the transverse tensile test was increased from 281 MPa to 535 MPa. The value of the resistance to alternating stress in the tensile swelling test (R=0) simultaneously increased from approximately 40 MPa to approximately 130 MPa.

The cause of the avoidance of the hot cracking is that it is possible during the solidification and cooling of the weld seam, at least in the temperature interval ΔT_{IS}, which is critical for hot cracking, to compensate for the thermal shrinking of the weld seam (7) sufficiently by the thermal volume increase of the two temperature fields (9, 10) generated by the volume energy source (22). FIG. 5 proves that this effect is actually responsible for this compensation and not the intervention in the cooling speed or the microstructure conversion in the weld seam. Using the same material, sample dimensions, and welding parameters, the effects of homogeneous additional temperature fields (sample heating in the furnace) and symmetrical local temperature fields having a temperature maximum in the join plane (33) or the weld seam (7) directly in front of the welding zone (4) or behind the solidification zone (6) were also studied. The value of the relative ultrasound echo was used as a measure for the cracking tendency. A decreasing crack number correlates with an increase of the value of the relative ultrasound echo; the samples are crack-free from a value of 85%. It may be seen from FIG. 5 that, as expected, inductive post-heating had no influence at all on the avoidance of hot cracks and crack-free states were not able to be achieved using furnace preheating or using inductive preheating having a temperature maximum in the join plane (33). Because the quenching speed, the local temperature in the surroundings of the welding zone, and the microstructure conversions were able to be changed in a similar value range using the alternative tested additional temperature fields, but without any decisive influence on the avoidance of cracking, as with the solution according to the invention, it is proven that the reduction of the thermal tensile elongations in the solidification zone is decisive.

### EXAMPLE 3

Tubular parts made of an austenitic rustless steel, which is susceptible to hot cracks, are to be bonded by laser beam welding. Conventional laser beam welding does not permit reliable avoidance of hot cracks.

The tube wall thickness is 6 mm. Because inductive energy coupling into the austenitic material is not as effectively possible as in a ferritic material, but, on the other hand, the electrical resistance and the resistive heating which may be generated are relatively great, a conductively acting auxiliary energy source suggests itself as the volume energy source for this case. For this purpose, as shown in FIG. 6, two roll-shaped power collectors (24, 25), which are mechanically connected to the welding head and comprise a copper alloy, are pressed springily against the surface of the components 1 and 2. Viewed in the feed direction (8), the two power collectors (24, 25) are located approximately 3 mm in front of the center line of the laser beam (3). The two lower power collectors (26, 27) are located approximately 5 mm behind the position of the two upper power collectors (24, 25).

Before the start of the welding process, the conductive current flow through the power collectors (24-26 or 25-27) and the components (1) and (2) is started. Two temperature fields, which penetrate the plate thickness d and are inclined to the surface, are generated by the resistive heating along the approximately tubular current path, which result in a thermal expansion of the heated volumes of the components (1) and (2). When the desired target temperature is reached, the laser used as the welding energy source (32) is switched in and the feed is started at the speed v_{S}. The two temperature fields (9, 10) thus generated result in a reduction of the tensile elongations in the solidification zone (7) during the passage of the temperature interval of brittleness ΔT_{IS} and thus ensure welding free of hot cracks.

1. A method for crack-free welding, repair welding, or buildup welding of material susceptible to hot cracking using a welding method of high power density and a further local temperature application, which travels at the welding speed at a constant distance to the welding zone, characterized in that the traveling local temperature application is performed by two electromagnetic temperature fields (9, 10), which run parallel or nearly parallel to the welding direction (8) and extend longitudinally to the welding direction (8), and which are generated by a volume energy source in the interior of the components 1 and 2 (1, 2) (22), both of which begin in front of the welding zone (4) in the welding direction (8) and whose temperature maxima (13) are located outside the thermal influence zone (14) and behind the solidification zone (6) in the welding direction (8), and the depths of the temperature fields (9, 10) at the location of the temperature maximum (13) at least reach the weld seam depth.

2. The method according to claim 1, characterized in that laser beam welding is used as the welding method of high power density.

3. The method according to claim 1, characterized in that a plasma, TIG, or WIG method is used as the welding method of high power density.

4. The method according to claim 1, characterized in that a non-vacuum electron beam welding method is used as the welding method of high power density.

5. The method according to claim 1, characterized in that the temperature fields (9, 10) are generated by inductive heating.

6. The method according to claim 1, characterized in that the temperature fields (9, 10) are produced by conductive heating.

7. The method according to claim 1, characterized in that the depth of the two temperature fields (9, 10), their distance, and their extension are set by the induction frequency, the length and distance of the two inductor branches (18, 19), the attachment of magnetic field amplification elements (21), and the inductive power.

8. The method according to claim 1, characterized in that, in the event of symmetrical heat dissipation conditions of the two components 1 and 2 (1, 2) and in the event of identical materials, the two temperature fields 1 and 2 (9, 10) are situated symmetrically to the location of the weld seam (7).

9. The method according to claim 1, characterized in that, in the event of different materials and/or asymmetrical heat dissipation conditions of the two components 1 and 2 (1, 2), the two temperature fields 1 and 2 (9, 10) are implemented differently in their extension, depth, and level of the temperature maxima Tₘₐₓ₁ and Tₘₐₓ₂, respectively.

10. A device for crack-free welding, repair welding, or buildup welding, comprising a welding energy source and an auxiliary energy source, characterized in that the auxiliary energy source is a volume energy source (22) and is connected to the welding head (23) and follows movement of the welding head (23).

11. The device according to claim 10, characterized in that the volume energy source (22) for generating the two temperature fields (9, 10) is formed by an inductor (15), which comprises two inductor branches 1 and 2 (18, 19), which run longitudinally or nearly longitudinally to the weld seam (22) and have a length lᵢ of 0.7 l_{SEZ}=lᵢ=30 l_{SEZ} and a distance bᵢ from one another of 1.5 b_{SZ}=bᵢ=20 b_{SZ}.

12. The device according to claim 10, characterized in that the inductor connection part (20) of the two inductor branches 1 (18) and 2 (19) has a coupling distance z₃ which is greater by at least a factor of 10 than the inductor branches 1 (18) and/or 2 (19).

13. The device according to claim 10, characterized in that the two inductor branches 1 (18) and 2 (19) are constructed differently in such a way that they have a different cross-section, coupling distance z₁ or z₂, a different length lᵢ₁ or lᵢ₂, or are provided at different lengths with magnetic field amplification elements (21).

14. The device according to claim 10, characterized in that the volume energy source (22) is formed by at least four power collectors (24, 25, 26, 27), which travel with the welding head, and which are located in electrical contact on the top (28, 30) and the bottom (29, 31) of the components 1 and 2 (1, 2) to be welded, outside the thermal influence zone (14) and behind the solidification zone (6) in the welding direction (8).

15. The device according to claim 14, characterized in that the power collectors (24, 26) located on the tops (28, 30) of the components 1 and 2 (1, 2) are situated leading the power collectors (25, 27) situated on the bottoms (29, 31) of the components 1 and 2 (1, 2).

16. A device to perform the method of claim 1 comprising a welding energy source and an auxiliary energy source, characterized in that the auxiliary energy source is a volume energy source (22) and is connected to the welding head (23) and follows movement of the welding head (23).
